(19) United States
(12) Patent Application Publication
(10) Pub. No.: US 2009/0133898 A1
(43) Pub. Date: May 28, 2009

(54) Flexible flat cable with carrier tape and manufacturing method thereof

(76) Inventors: Tetsuji Kojima, Ishikawa (JP); Hisaya Tamura, Ishikawa (JP)

Correspondence Address: KANESAKA BERNER AND PARTNERS LLP, 1700 DIAGONAL RD, SUITE 310, ALEXANDRIA, VA, 22314-2848, US

(21) Appl. No.: 11/991,166

(22) PCT Filed: Jun. 1, 2007
(86) PCT No.: PCT/JP2007/061167

§ 371 Date: Feb. 28, 2008

(30) Foreign Application Priority Data
Jun. 16, 2006 (JP) 2006-167518

(51) Int. Cl. H01B 7/08

(52) U.S. Cl. 174/117 F; 156/50

(57) ABSTRACT

It is to provide a flexible flat cable with a carrier tape capable of preventing conductors from being bent without increasing the cost of production.

The flexible flat cable with the carrier includes a plurality of flexible flat cables 2 each of which has a plurality of conductors 2a sandwiched between two insulating materials 2b and arrayed substantially in parallel at a prescribed pitch, with the conductors 2a at opposite ends of each flexible flat cable exposed in a prescribed length, and a carrier tape 3 for supporting thereon surfaces of the flexible flat cables on one side thereof. The plural flexible flat cables are continuously arrayed and laminated with the carrier tape 3 in a state in which the conductors are individually cut off in half.

### TECHNICAL FIELD

The present invention relates to a flexible flat cable with a carrier tape, which has the flexible flat cable supported on the carrier tape and is used as a interconnection cable in various kinds of electron devices, and to a manufacturing method thereof, and particularly to a technique to spectacularly improve the handleability of a flexible flat cable having a conductor exposed to the opposite ends thereof.

### BACKGROUND ART

A flexible flat cable (FFC) has widely been used as a junction cable laid between parts or interconnection substrates disposed inside an electron device, such as a printer, a scanner, etc., for example. Since the flexible flat cable has excellent flexibility, it can be used for a movable portion and, since it has a merit of lowering the manufacturing costs incurred in comparison with a flexible printed cable (FPC) board, it has been in heavy usage in a whole range of fields.

The flexible flat cable comprises thin plate conductors having a prescribed width (so-called straight angle conductors) and insulating materials sandwiching the conductors therebetween, and each conductor functions as a wiring for electrical interconnection. When connecting each conductor to a prescribed terminal of a part or an interconnection substrate, therefore, the flexible flat cable has the insulating materials removed from the opposite sides thereof to expose the conductor. When connecting the flexible flat cable, the exposed conductor is soldered to the terminal of the part or interconnection substrate for electrical interconnection and fixed mechanically thereto.

Meanwhile, since the flexible flat cable subjected to soldering is handled, with the conductor projecting therefrom, the conductor is prone to problematic defects, such as bending. The thin plate conductor is bent with the application of a slight force and when handling the flexible flat cable, with the conductor projecting therefrom, as described above, the conductor is frequently bent. The bent conductor produces a significant hindrance to soldering, resulting in a cause of deteriorating the workability. In addition, when collectively handling flexible flat cables each having a conductor projecting therefrom, the projecting parts of the conductor may possibly be entangled with other flexible flat cables to deteriorate the workability. This is also problematic.

Under these circumstances, a single-sided tape has been attached to the projecting conductor part for the purpose of preventing its bending to secure the strength of the conductor (refer to Patent Document 1, for example).

In Patent Document 2, is disclosed a flat cable comprising two insulating tapes, plural conductors sandwiched between the tapes and disposed in parallel at regular intervals, with the conductors at the opposite ends exposed over a constant length to function as connection terminal parts, and terminal protective films partially attached to the ends of the insulating tape on one surface of the flat cable to cover the tape ends and the connection terminal parts in a state capable of being easily exfoliated, wherein the terminal protective films are provided with adhesion layers of a small width disposed substantially at right angles relative to the longitudinal direction of the flat cable and wherein the adhesion layers have a thickness not to contact the surfaces of the insulating tapes positioned at the conductor interval portions of the flat cable. The invention described in Patent Document 1 adopts a structure in which the terminal protective films can easily be split off the insulating films through pulling thereof in the orthogonal or oblique direction relative to the longitudinal direction of the tapes besides the mere attachment of the one-sided tapes (terminal protective films) to the projecting conductor portions.

Patent Document: JP-A 2000-149668

### DISCLOSURE OF THE INVENTION

### Problems the Invention Intends to Solve:

In the method described in the invention set forth in Patent Document 1 of attaching the single-sided tape (terminal protective film), since a terminal protective film should be attached to the individual flexible flat cables in two places, the operation becomes cumbersome to increase the manufacturing cost. The flexible flat cable has a merit in that it can be manufactured at low cost relative to the flexible printed circuit board. However, the increase in manufacturing cost will deteriorate the merit of a flexible flat cable. Furthermore, a work of exfoliating the terminal protective film is required and curling of the conductors is prone to occur.

When handling flexible flat cables having a small length, problems lie in that since they are difficult to carry the workability is not good and that since they are difficult to array the working efficiency is not good. The attachment of the terminal protective films as disclosed in Patent Document 1 cannot solve these problems.

The present invention has been proposed in view of the conventional actual situation, and the object thereof is to provide a flexible flat cable with a carrier tape capable of preventing bending of conductors and suppressing generation of defective goods without highly increasing the cost of manufacturing and to provide a manufacturing method thereof. Another object of the present invention is to a flexible flat cable with a carrier tape easy to handle even when it has a small length and excellent in handleability to enable the man-hour reduction.

### Means for Solving the Problems:

To achieve the above objects, the present invention provides a flexible flat cable with a carrier tape, comprising a plurality of flexible flat cables each of which includes two insulating materials and a plurality of conductors sandwiched between the insulating materials and disposed substantially in parallel at a prescribed pitch, with the conductors at opposite ends of each flexible flat cable exposed in a prescribed length, and a carrier tape for supporting thereon surfaces of the flexible flat cables on one side thereof, the plurality of flexible flat cables being continuously arrayed on the carrier tape in an individually cut-off state and laminated with the carrier tape.

The present invention further provides a method for manufacturing a flexible flat cable with a carrier tape, comprising the steps of laminating with a carrier tape a flexible flat cable blank having sandwiched between two insulating materials a plurality of conductors arrayed in parallel at a prescribed pitch and having the insulating materials removed at a prescribed interval to expose the conductors at the prescribed interval, and exclusively cutting off each of the exposed conductors in half to separate the flexible flat cable blank into individual flexible flat cables.

In the flexible flat cable with the carrier tape according to the present invention, since the exposed conductors are supported on the carrier tape, similarly to the case where the terminal protective film is attached as described in Patent Document 1, the strength of the conductors is secured to suppress the conductors from being bent. In addition, since the flexible flat cables of a prescribed length are continuously laminated with the carrier tape, they are easy to handle even when they have a small length, the conductors will not be entangled with each other to eliminate an arraying operation, thereby making the handleability better to enhance the working efficiency to a great extent.

On the other hand, in the manufacturing method of the present invention, the flexible flat cable blank is laminated with the carrier tape and then the conductors are cut off in half to separate the flexible flat cable blank into individual flexible flat cables. Therefore, it is unnecessary to attach the individual flexible flat cables to the carrier tape one by one to produce the flexible flat cable with the carrier tape having the aforementioned configuration with high productivity. Furthermore, there is no need to particularly position the flexible flat cable blank when attaching it to the carrier tape and, in this aspect, the simplification of the steps can be realized.

### Effects of the Invention

According to the present invention, it is made possible to provide a flexible flat cable capable of preventing bending of the conductors and suppressing generation of defective goods without highly increasing the cost of manufacturing. In addition, even flexible flat cables having a small length are easy to handle and excellent in handleability to enable the man-hour reduction.

### BEST MODE FOR CARRYING OUT THE INVENTION

The embodiments of the flexible flat cable with the carrier tape and the manufacturing method according to the present invention will be described with reference to the accompanying drawings.

FIG. 1 shows one example of a flexible flat cable with a carrier tape according to the present embodiment. The flexible flat cable 1 with a carrier tape comprises flexible flat cables 2 of a prescribed length laminated in a row with a long carrier tape 3. While the flexible flat cables 2 are cut into individuals, the carrier tape 3 is a continuous body. Therefore, the adoption of this configuration enables the flexible flat cables 2 to be handled even when having a small length in the same manner as long flexible flat cables.

In each flexible flat cable 2, thin plate conductors 2a having a predetermined width are disposed substantially in parallel and laminated with two upper and lower insulating materials 2b. As a result, each conductor 2a is sandwiched between the two upper and lower insulating materials 2b and protected thereon. In addition, in each flexible flat cable 2, the conductors are exposed in a prescribed length to the opposite ends of the flexible flat cable. The exposed conductors 2a are to be soldered for connection. Thus, the flexible flat cables 2a are configured to be capable of replying to soldering.

The conductors 2a constituting the flexible flat cable 2 are so-called straight angle conductors and are made of an optional conductive material (metal), such as a straight angle soft copper wire plated with tin. The dimension and the number of the conductor 2a are also optional. For example, the conductor 2a has a thickness of around 35 μm to 100 μm and a width of around 0.3 mm to 0.8 mm. The pitch between the conductors is around 0.5 mm to 1.25 mm, for example. The number of the conductors 2a to be disposed (number of cores) is around 4 to 60, for example.

The insulating materials 2b sandwiching the conductors 2a is made of a resin having an insulating property, such as polyethylene terephthalate, for example. The insulating materials 2a preferably contain no halogen so as not to induce a harmful substance when being combusted.

On the other hand, the carrier tape 3 supporting the flexible flat cables 2 thereon enables the flexible flat cables 2 to be handled in the same manner as a continuous flexible flat cable and reinforces (protects) the conductors 2a projecting from each of the flexible flat cables 2. Therefore, it can be made of any of materials having this function, such as polyethylene terephthalate. Incidentally, the carrier tape 3 is preferred to be a transparent carrier tape that enables the induction of defective flexible flat cables 2 and the interfusion of extraneous substances to be examined therethrough.

In addition, a tackiness agent or adhesive agent is applied onto one surface of the carrier tape 3 to bond the flexible flat cables 2 thereto. Here, the tackiness agent or adhesive agent is preferred to be of a slightly tacky type to enable each of the flexible flat cables 2 to be exfoliated with ease.

The flexible flat cable 1 with the carrier tape having the configuration as described above, even when each of the flexible flat cables 2 has a small length, can be handled in the same manner as a long continuous flexible flat cable. That is to say, when handling the flexible flat cables 2, it is unnecessary to pick up them one by one by hand, thereby materializing the reduction of man-hour. In addition, since the conductors 2a of each flexible flat cable 2 are reinforced with the carrier tape 3, bending of the conductors 2a can be prevented. Furthermore, there is no case where the conductors 2a are entangled with each other.

The flexible flat cable 1 with the carrier tape can be handled in a wound state as shown in FIG. 2, for example. The flexible flat cable 1 with the carrier tape handled in the wound state facilitates the storage thereof and, in use, is wound off by a necessary length to enable the flexible flat cable or cables 2 to be handled.

In the flexible flat cable 1 with the carrier tape, since a continuous flexible flat cable blank not cut off is laminated with a carrier tape 3 and portions thereof are then cut off in half, respectively, to form individual separate flexible flat cables 2, the flexible flat cables 2 are orderly arrayed in the laminated state. Therefore, the flexible flat cable 1 with the carrier tape is wound off by a necessary length to enable the flexible flat cables 2 to be sequentially taken out and easily enables automation, for example. By exfoliating the carrier tape 3 in the direction of an angle of 180°, the flexible flat cable 2 can be taken out promptly.

Next, the method for manufacturing the flexible flat cable 1 with the carrier tape will be described. As described above, a continuous flexible flat cable blank not cut off is laminated with a carrier tape 3 and portions thereof are then cut off in half, respectively, to form individual separate flexible flat cables 2.

FIG. 3 shows one example of an apparatus for manufacturing the flexible flat cable with the carrier tape, and FIG. 4 is a cross section taken along line A-A in FIG. 3.

The apparatus for manufacturing the flexible flat cable with the carrier tape comprises guide rolls 21 and 22 for guiding a flexible flat cable blank 11 and a carrier tape 3, respectively, a positioning mechanism 23 for positioning in the width direction the flexible flat cable blank 11 and the carrier tape 3 both supplied, laminating rolls 24 and 25 for laminating the flexible flat cable blank 11 with the carrier tape 3 and a cutter for cutting off the flexible flat cable blank 11 after the lamination.

Here, the flexible flat cable blank 11 comprises conductors 11a and insulating materials 11b which are partially exfoliated to expose the conductors 11a at prescribed intervals in a prescribed length. For this reason, the flexible flat cable blank 11 is retained in a long state in the presence of the conductors 11a. On the other hand, as the carrier tape 3, a transparent film of polyethylene terephthalate is used. The transparent carrier tape 3 enables the flexible flat cable blank 11 bonded thereto to be discernibly confirmed through the carrier tape 3.

In manufacturing a flexible flat cable with a carrier tape, the flexible flat cable blank 11 and the carrier tape 3 are supplied so as to be opposed to each other while being guided by means of guide rolls 21 and 22. The flexible flat cable blank 11 and the carrier tape 3 are positioned in the width direction using a positioning mechanism 23. The positioning mechanism 23 comprises a support 23a, a first guide plate 23b provided on the support and formed with a slit having substantially the same width as the carrier tape 3 and a second guide plate 23c formed with a slit having substantially the same width as the flexible flat cable blank 11. The flexible flat cable blank 11 and the carrier tape 3 are positioned by the functions of the first and second guide plates 23b and 23c.

The flexible flat cable blank 11 and the carrier tape 3 thus positioned relative to each other are then passed through laminating rolls 24 and 25 to be subjected to lamination coating. A tackiness agent is applied to the surface of the carrier tape 3 facing the flexible flat cable blank 11, and the lamination coating of the flexible flat cable blank 11 with the carrier tape 3 is completed through application of a pressure by the laminating rolls 24 and 25.

After the lamination coating, the flexible flat cable blank 11 is cut off using a cutter 26 into individual flexible flat cables 2. This cutting-off operation is performed through cutting off each of the exposed conductors 11 in half, and as a result, each cut flexible flat cable 2 has the conductors 2a exposed to the opposite sides. This cutting-off operation does not cut off the carrier tape 3.

Incidentally, the manufacturing apparatus in this embodiment has a sensor 27 disposed at a position short of the cutter 26 for detecting the positions of the exposed conductors 11a of the flexible flat cable blank 11 and the height and position of the conductors 11a or the carrier tape 3, thereby performing the cutting-off operation at appropriate positions.

In addition, defective parts of the flexible flat cable blank 11 lamination-coated with the carrier tape 3 and interfusion of extraneous substances may be examined through the sensor 27 (or another sensor or visual examination. Furthermore, defective flexible flat cables 2 lamination-coated with the carrier tape 3 and interfusion of extraneous substances after the cutting-off operation may be examined. This examination can easily be made without purposely exfoliating the flexible flat cable blank 11 or flexible flat cables 2 because the carrier tape 3 is made transparent.

According to the manufacturing method described above, plural flexible flat cables 2 are laminated with the carrier tape 3 in a lump and, therefore, the working efficiency can be enhanced to a great extent in comparison with the case where a terminal protective film is attached to the conductors 2a. In addition, since the cut-off flexible flat cables 2 are self-arrayed orderly on the carrier tape 3, no arraying operation is required to further enhance the working efficiency in this respect.

While the embodiments of the present invention have been described above, it goes without saying that the present invention is not limited to these embodiments. The shapes and sizes of the component elements, for example, can be variously modified.

### BRIEF DESCRIPTION OF THE DRAWINGS

FIG. 1 It is a schematic perspective view showing one example of a flexible flat cable with a carrier tape according to the present invention.

FIG. 2 It is a schematic perspective view showing the flexible flat cable with the carrier tape wound in a used state.

FIG. 3 It is an explanatory view showing one example of an apparatus for manufacturing the flexible flat cable with the carrier tape.

FIG. 4 It is a cross-sectional view taken along line A-A in FIG. 3.

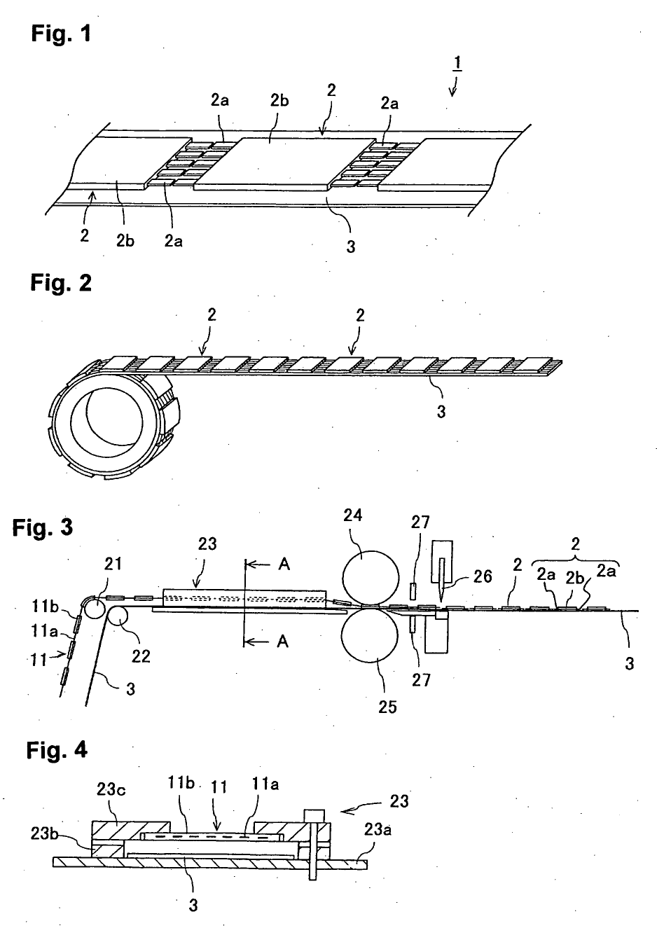

### EXPLANATION OF REFERENCE NUMERALS

1: a flexible flat cable with a carrier tape, 2: a flexible flat cable, 2a: a conductor, 2b: an insulating material, 3: a carrier tape, 11: an original plate for the flexible flat cable, 11a: a conductor, 11b: an insulating material, 21 and 22: guide rolls, 23: a positioning mechanism, 23a: a support, 23b: a first guide plate, 23c: a second guide plate, 24 and 25: laminating rolls, 26: a cutter, and 27: a sensor.

1. A flexible flat cable with a carrier tape, comprising:
a plurality of flexible flat cables each of which includes two insulating materials and a plurality of conductors sandwiched between the insulating materials and arrayed substantially in parallel at a prescribed pitch, with the conductors at opposite ends of each flexible flat cable exposed in a prescribed length; and
a carrier tape for supporting thereon surfaces of the flexible flat cables on one side thereof,
the plurality of flexible flat cables being continuously arrayed on the carrier tape in an individually cut-off state and laminated with the carrier tape.

2. A flexible flat cable with a carrier tape according to claim 1, wherein the carrier tape is transparent.

3. A flexible flat cable with a carrier tape according to claim 1, wherein the carrier tape is made of polyethylene terephthalate.

4. A flexible flat cable with a carrier tape according to claim 1, wherein the carrier tape has an a tackiness agent applied to a surface thereof and the plurality of flexible flat cables are laminated with the carrier in a slightly tacky adhesion state.

5. A flexible flat cable with a carrier tape according to claim 1, wherein it is used in a wound-state.

6. A method for manufacturing a flexible flat cable with a carrier tape, comprising the steps of:
laminating with a carrier tape a flexible flat cable blank having sandwiched between two insulating materials a plurality of conductors arrayed in parallel at a prescribed pitch and having the insulating materials removed at a prescribed interval to expose the conductors at the prescribed interval, and
exclusively cutting off each of the exposed conductors in half to separate the flexible flat cable blank into individual flexible flat cables.

7. A method for manufacturing a flexible flat cable with a carrier tape according to claim 6, wherein the step of laminating the flexible flat cable blank with the carrier tape is performed in a state in which the flexible flat cable blank and the carrier tape are positioned with a jig.

8. A method for manufacturing a flexible flat cable with a carrier tape according to claim 6, wherein the flexible flat cable blank is laminated with the carrier tape with a laminate.

9. A method for manufacturing a flexible flat cable with a carrier tape according to any one of claim 6, wherein the carrier tape is transparent and further comprising the step of examining the flexible flat cable blank or the flexible flat cables laminated with the carrier tape.
